(19) United States
(12) Patent Application Publication
(10) Pub. No.: US 2022/0173686 A1
(43) Pub. Date: Jun. 2, 2022

(54) ELECTROMECHANICALLY INTEGRATED UNIT

(71) Applicant: TOYOTA JIDOSHA KABUSHIKI KAISHA, Toyota-shi (JP)

(72) Inventor: Keisuke YUKI, Toyota-shi (JP)

(73) Assignee: TOYOTA JIDOSHA KABUSHIKI KAISHA, Toyota-shi (JP)

(21) Appl. No.: 17/470,513

(22) Filed: Sep. 9, 2021

(30) Foreign Application Priority Data
Dec. 2, 2020 (JP) 2020-200073

(51) Int. Cl. H02P 27/06; H02K 5/22; H02M 1/00

(52) U.S. Cl. CPC H02P 27/06; H02P 2201/07; H02M 1/007; H02K 5/22

(57) ABSTRACT

An electromechanically integrated unit is provided which includes a motor module, a first power converter circuit, a first case, a second power converter circuit, a second case, and a wall. The motor module contains a motor. The first power converter circuit is connected to the motor. The first case houses the first power converter circuit, is mounted on the motor module, and includes a first surface. The second power converter circuit is connected to the first power converter circuit. The second case houses the second power converter circuit, is mounted on the first case, and includes a second surface facing the first surface of the first case. The wall surrounds, between the first surface of the first case and the second surface of the second case, at least a part of a space between the first surface and the second surface.

### CROSS-REFERENCE TO RELATED APPLICATION

This application claims priority to Japanese Patent Application No. 2020-200073 filed on Dec. 2, 2020, incorporated herein by reference in its entirety.

### BACKGROUND

### 1. Technical Field

A technique disclosed in the specification relate to electromechanically integrated units.

### 2. Description of Related Art

Japanese Unexamined Patent Application Publication No. 2013-115903 (JP 2013-115903 A) discloses an electromechanically integrated unit. This electromechanically integrated unit includes: a motor module containing a motor; and a power converter electrically connected to the motor. The power converter has a power converter circuit such as an inverter circuit and a case that houses the power converter circuit, and the case is mounted on a housing for the motor module.

### SUMMARY

The electromechanically integrated unit may include two or more power converter circuits such as a combination of a direct current to direct current (DC-to-DC) converter circuit and an inverter circuit. In this case, the two power converter circuits may be housed in separate cases, and these cases may be mounted on top of each other on the motor module. With such a configuration, however, vibration from the motor module sequentially propagates to the two cases, causing each of the two cases to vibrate. In the case where there is a space between the two cases, spatial resonance may occur in the space at this time, and noise due to the vibration from the motor module may be excessively amplified. In view of the above, the specification provides a technique capable of reducing noise that is generated from an electromechanically integrated unit.

An aspect of the present disclosure relates to an electromechanically integrated unit including: a motor module containing a motor; a first power converter circuit connected to the motor; a first case; a second power converter circuit connected to the first power converter circuit; a second case; and a wall. The first case houses the first power converter circuit, is mounted on the motor module, and includes a first surface. The second case houses the second power converter circuit, is mounted on the first case, and includes a second surface facing the first surface of the first case. The wall is configured to surround at least a part of a space between the first surface of the first case and the second surface of the second case.

According to the electromechanically integrated unit of the above aspect, the first surface (e.g., top surface) of the first case that houses the first power converter circuit and the second surface (e.g., bottom surface) of the second case that houses the second power converter circuit face each other. Therefore, such spatial resonance as described above may occur between the first surface of the first case and the second surface of the second case. According to the electromechanically integrated unit of the above aspect, however, the wall is provided which surrounds, between the first surface of the first case and the second surface of the second case, at least a part of the space between the first surface and the second surface. Accordingly, even if spatial resonance occurs between the two cases, namely between the first case and the second case, the wall reduces leakage of noise due to the spatial resonance to the outside.

In the electromechanically integrated unit of the above aspect, the wall may be provided on either or both of the first surface of the first case and the second surface of the second case. According to the electromechanically integrated unit having the above configuration, in the case where, e.g., at least a part of the wall is provided on the first surface of the first case, rigidity of the first surface is increased, and vibration of the first surface is therefore reduced. Spatial resonance between the first case and the second case can thus be reduced. Similarly, even in the case where at least a part of the wall is provided on the second surface of the second case, spatial resonance between the first case and the second case can be reduced. The wall may be composed of members that are independent of the first case and the second case.

In the electromechanically integrated unit of the above aspect, the wall may include a first part and a second part, the first part being provided on the first surface of the first case, a second part being provided on the second surface of the second case and facing the first part. According to the electromechanically integrated unit having the above configuration, rigidity of the first surface of the first case and rigidity of the second surface of the second case are increased, and spatial resonance between the first surface of the first case and the second surface of the second case can be more effectively reduced.

In the electromechanically integrated unit of the above aspect, the wall may include a peripheral wall configured to form an enclosure between the first surface of the first case and the second surface of the second case, and a partition wall configured to divide a space surrounded by the peripheral wall into a first space and a second space. According to the electromechanically integrated unit having the above configuration, since the space surrounded by the wall is divided into the smaller spaces, spatial resonance that occurs between the two cases and leakage of noise due to the spatial resonance can be effectively reduced.

In the electromechanically integrated unit having the above configuration, in a direction in which the first surface of the first case and the second surface of the second case face each other, a dimension of the first space and a dimension of the second space may be different from each other. According to the electromechanically integrated unit having the above configuration, since a resonance frequency is different between the first space and the second space, occurrence of spatial resonance and amplification of noise due to the spatial resonance can be reduced.

In the electromechanically integrated unit having the above configuration, in a direction in which the first surface of the first case and the second surface of the second case face each other, a dimension of the first space may be smaller than a dimension of the second space. According to the electromechanically integrated unit having the above configuration, since a resonance frequency is different between the first space and the second space, occurrence of spatial resonance and amplification of noise due to the spatial resonance can be reduced.

In the electromechanically integrated unit having the above configuration, a cover may be provided on either the first case or the second case, the cover being interposed between the first surface of the first case and the second surface of the second case. In this case, the dimension of the first space may be defined by the cover and the other of the first case and the second case.

In the electromechanically integrated unit having the above configuration, a surface of the cover that faces the first space may have an uneven shape. According to the electromechanically integrated unit having the above configuration, since the surface of the cover has the uneven shape, rigidity of the cover is increased, and vibration of the cover is therefore reduced. Moreover, due to the uneven shape of the surface of the cover, the resonance frequency in the first space also changes variously. Occurrence of spatial resonance and amplification of noise due to the spatial resonance can therefore be effectively reduced.

In the electromechanically integrated unit having the above configuration, the cover may be provided on the second case. In this case, a coolant passage configured to cool the second power converter circuit may be defined between the cover and the second surface of the second case.

In the electromechanically integrated unit having the above configuration, the cover may include a plurality of fixing portions at a peripheral edge of the cover, the fixing portions being fixed to the second case. In this case, the fixing portions may be located outside the first space. According to the electromechanically integrated unit having the above configuration, the cover can be supported by the wall at a position inward of the fixing portions. Vibration of the cover can therefore be reduced.

In the electromechanically integrated unit of the above aspect, the first power converter circuit may be an inverter circuit, and the second power converter circuit may be a converter circuit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of an electromechanically integrated unit of an embodiment that is an example of the present disclosure;

FIG. 2 is an electrical circuit diagram of the electromechanically integrated unit;

FIG. 3 illustrates a structure between an inverter module and a converter module that are shown in FIG. 1;

FIG. 4 is a plan view of the electromechanically integrated unit, where the converter module other than a flow path cover is not shown; and

FIG. 5 is a sectional view taken along line V-V in FIG. 4.

### DETAILED DESCRIPTION OF EMBODIMENTS

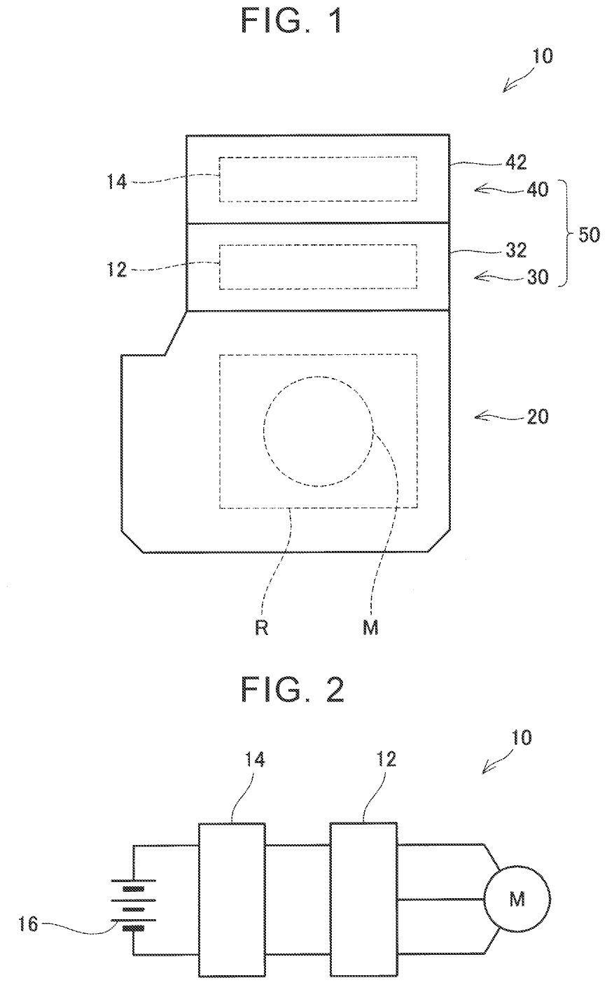

An electromechanically integrated unit 10 according to an embodiment of the present disclosure will be described with reference to the accompanying drawings. The electromechanically integrated unit 10 can be used in electrically powered vehicles such as electric vehicles, fuel cell vehicles, and hybrid vehicles. As shown in FIGS. 1 and 2, the electromechanically integrated unit 10 includes a motor module 20 and a power converter 50. The electromechanically integrated unit 10 is a single unit composed of the motor module 20 and the power converter 50. The motor module 20 contains a motor M and a speed reducer R connected to the motor M. Electric power is supplied from a battery 16 to the motor M via the power converter 50. Torque output from the motor M is transmitted to wheels of an electrically powered vehicle via the speed reducer R.

The power converter 50 includes an inverter module 30 and a converter module 40. The inverter module 30 includes an inverter circuit 12 and an inverter case 32 that houses the inverter circuit 12. The converter module 40 includes a converter circuit 14 and a converter case 42 that houses the converter circuit 14. The inverter case 32 is mounted on the motor module 20. The converter case 42 is mounted on the inverter case 32. The inverter case 32 and the converter case 42 are thus mounted on top of each other on the motor module 20. The inverter case 32 in the present embodiment is an example of the first case in the present technique, and the converter case 42 in the present embodiment is an example of the second case in the present technique.

The motor M is connected to the battery 16 via the inverter circuit 12 and the converter circuit 14. The converter circuit 14 is a DC-to-DC converter. The converter circuit 14 boosts DC power supplied from the battery 16 and outputs the resultant DC power to the inverter circuit 12. The inverter circuit 12 has a three-phase alternating current (AC) inverter circuit structure. The inverter circuit 12 converts the DC power output from the converter circuit 14 to three-phase AC power and outputs the three-phase AC power to the motor M.

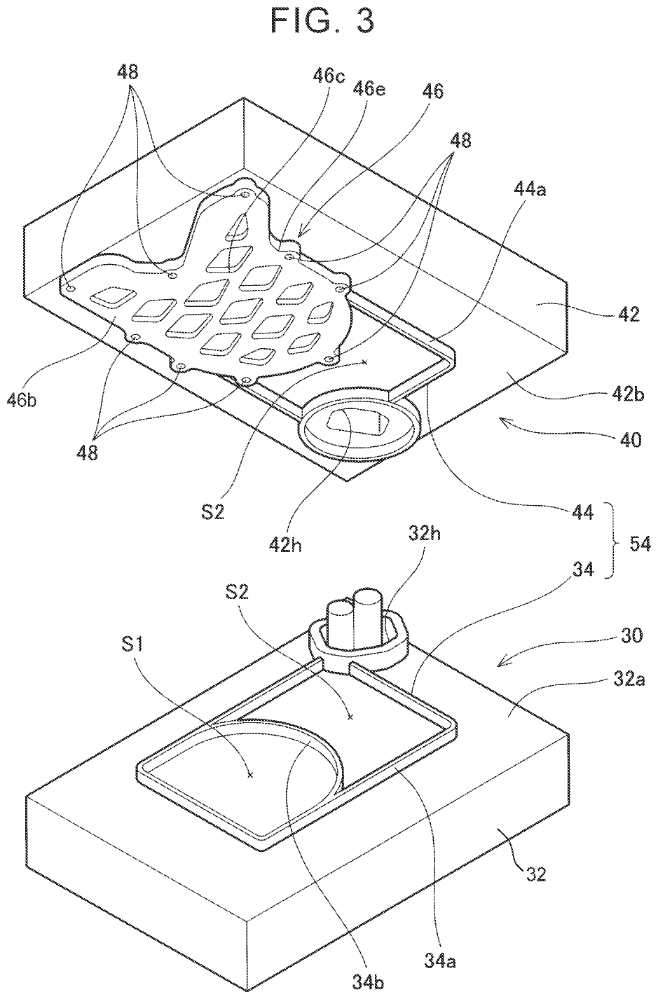

As shown in FIG. 3, the inverter case 32 has, e.g., a box shape and includes a top surface 32a located on the converter case 42 side. The converter case 42 also has, e.g., a box shape and includes a bottom surface 42b located on the inverter case 32 side. The top surface 32a of the inverter case 32 and the bottom surface 42b of the converter case 42 face each other. The top surface 32a of the inverter case 32 in the present embodiment is an example of the first surface of the first case in the present technique, and the bottom surface 42b of the converter case 42 in the present embodiment is an example of the second surface of the second case in the present technique.

The top surface 32a of the inverter case 32 includes a hole 32h, and the bottom surface 42b of the converter case 42 includes a hole 42h. A cable that connects the inverter circuit 12 and the converter circuit 14 is disposed so as to pass through the holes 32h, 42h.

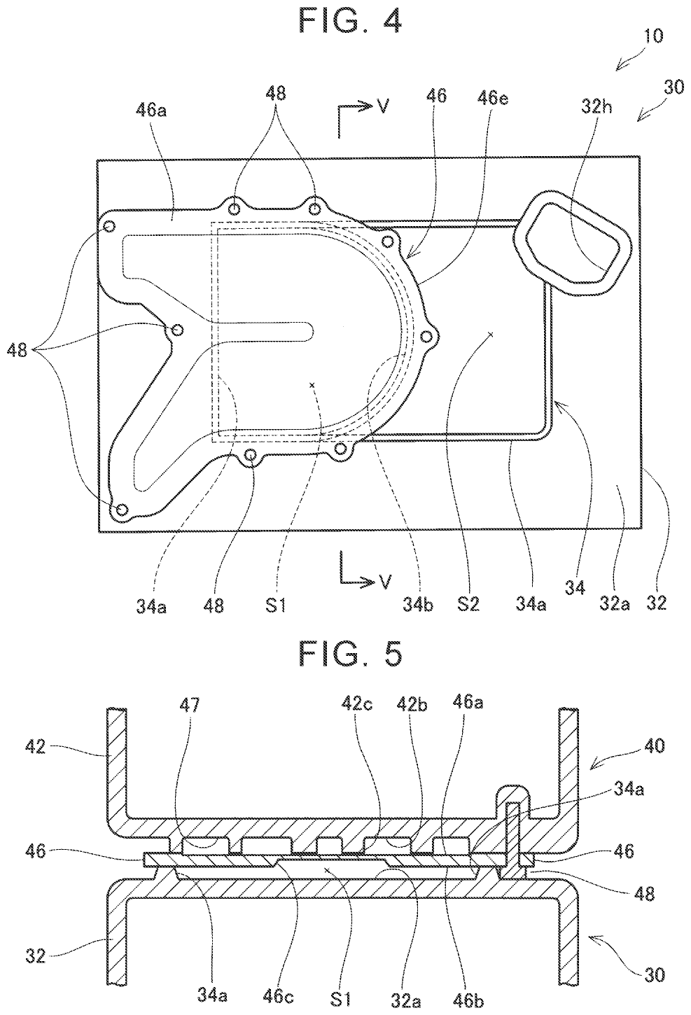

As shown in FIGS. 3 to 5, a flow path cover 46 is provided on the bottom surface 42b of the converter case 42. The flow path cover 46 in the present embodiment is an example of the cover in the present technique. The flow path cover 46 is generally a plate member. The flow path cover 46 is attached to the converter case 42 at a plurality of fixing portions 48, although the flow path cover 46 is not particularly limited to this configuration. The fixing portions 48 are arranged along a peripheral edge 46e of the flow path cover 46. Each fixing portion 48 is fixed to the converter case 42 using a fastening member such as, e.g., a bolt.

A top surface 46a of the flow path cover 46 faces the bottom surface 42b of the converter case 42. A coolant passage 47 configured to cool the converter circuit 14 is defined between the top surface 46a of the flow path cover 46 and the bottom surface 42b of the converter case 42. A bottom surface 46b of the flow path cover 46 faces the top surface 32a of the inverter case 32. The bottom surface 46b of the flow path cover 46 has an uneven shape 46c. Rigidity of the flow path cover 46 is thus increased.

The bottom surface 42b of the converter case 42 includes a plurality of protrusions 42c. The protrusions 42c are provided in an area facing the flow path cover 46 and divide the coolant passage 47 into a plurality of passages. A cooling medium that flows through the coolant passage 47 thus easily spreads across the entire coolant passage 47, and the cooling capability for cooling the converter circuit 14 is increased. Moreover, the presence of the protrusions 42c increases rigidity of the converter case 42.

A soundproof wall 54 is provided between the top surface 32a of the inverter case 32 and the bottom surface 42b of the converter case 42. The soundproof wall 54 in the present embodiment is an example of the wall in the present technique. The soundproof wall 54 is provided so as to surround the space between the top surface 32a of the inverter case 32 and the bottom surface 42b of the converter case 42. In a direction in which the top surface 32a of the inverter case 32 and the bottom surface 42b of the converter case 42 face each other (hereinafter referred to as the height direction), the dimension of this space is substantially equal to the dimension of the soundproof wall 54. The dimension of the soundproof wall 54 may be smaller than the dimension of the space within manufacturing tolerance.

The soundproof wall 54 includes a lower part 34 provided on the inverter case 32 and an upper part 44 provided on the converter case 42. The lower part 34 in the present embodiment is an example of the first part in the present technique and the upper part 44 in the present embodiment is an example of the second part in the present technique. The lower part 34 of the soundproof wall 54 is formed integrally with the top surface 32a of the inverter case 32 and protrudes upward toward the converter case 42. The upper part 44 of the soundproof wall 54 is formed integrally with the bottom surface 42b of the converter case 42 and protrudes downward toward the inverter case 32. The lower part 34 of the soundproof wall 54 provided on the inverter case 32 faces the upper part 44 or the flow path cover 46 provided on the converter case 42. At least a part of the soundproof wall 54 may be formed by a separate member that is independent of the inverter case 32 and the converter case 42. Alternatively, at least a part of the soundproof wall 54 may be formed integrally with the bottom surface 46b of the flow path cover 46.

The soundproof wall 54 includes peripheral walls 34a, 44a and a partition wall 34b. The peripheral walls 34a, 44a have a frame shape and are provided so as to form an enclosure. The partition wall 34b is provided inside the peripheral walls 34a, 44a and divides the space surrounded by the peripheral walls 34a into a first space S1 and a second space S2. As an example, the partition wall 34b in the present embodiment is provided on the top surface 32a of the inverter case 32, and particularly is provided in the area facing the flow path cover 46. The first space S1 is therefore defined between the top surface 32a of the inverter case 32 and the bottom surface 46b of the flow path cover 46. The second space S2 is located outside the flow path cover 46 and is defined between the top surface 32a of the inverter case 32 and the bottom surface 42b of the converter case 42.

In the electromechanically integrated unit 10 of the present embodiment, the inverter case 32 that houses the inverter circuit 12 and the converter case 42 that houses the converter circuit 14 are mounted on top of each other on the motor module 20. The top surface 32a of the inverter case 32 and the bottom surface 42b of the converter case 42 thus face each other. With such a structure, spatial resonance may occur between the top surface 32a of the inverter case 32 and the bottom surface 42b of the converter case 42. In this case, noise due to vibration from the motor module 20 may be excessively amplified by the spatial resonance.

In this respect, in the electromechanically integrated unit 10 of the present embodiment, the soundproof wall 54 is provided between the top surface 32a of the inverter case 32 and the bottom surface 42b of the converter case 42. The soundproof wall 54 is provided so as to surround at least a part of the space between the top surface 32a of the inverter case 32 and the bottom surface 42b of the converter case 42. With such a configuration, even if spatial resonance occurs between the two cases 32, 42, the soundproof wall 54 reduces leakage of noise due to the spatial resonance to the outside. Noise generated from the electromechanically integrated unit 10 can thus be significantly reduced.

In the electromechanically integrated unit 10 of the present embodiment, the lower part 34 of the soundproof wall 54 is formed integrally with the top surface 32a of the inverter case 32. The upper part 44 of the soundproof wall 54 is formed integrally with the bottom surface 42b of the converter case 42. According to such a configuration, rigidity of the top surface 32a of the inverter case 32 and rigidity of the bottom surface 42b of the converter case 42 are increased, and spatial resonance between the top surface 32a of the inverter case 32 and the bottom surface 42b of the converter case 42 can be more effectively reduced.

In the electromechanically integrated unit 10 of the present embodiment, the soundproof wall 54 includes the peripheral walls 34a, 44a that form an enclosure between the inverter case 32 and the converter case 42, and the partition wall 34b that divides the space surrounded by the peripheral walls 34a, 44a into the first space S1 and the second space S2. With such a configuration, since the space surrounded by the soundproof wall 54 is divided into the smaller spaces S1, S2, spatial resonance that occurs between the two cases 32, 42 and leakage of noise due to the spatial resonance can be effectively reduced.

In the electromechanically integrated unit 10 of the present embodiment, the height dimension (dimension in the height direction) of the first space S1 is smaller than the height dimension of the second space S2. That is, the height dimension of the first space S1 is equal to the distance from the top surface 32a of the inverter case 32 to the bottom surface 46b of the flow path cover 46. The height dimension of the second space S2 is equal to the distance from the top surface 32a of the inverter case 32 to the bottom surface 42b of the converter case 42. As can be seen from the above description, the distance from the bottom surface 46b of the flow path cover 46 to the top surface 32a of the inverter case 32 is smaller than the distance from the top surface 32a of the inverter case 32 to the bottom surface 42b of the converter case 42. The height dimension of the first space S1 is therefore smaller than the height dimension of the second space S2. When the height dimension is different between the first space S1 and the second space S2 as described above, the resonance frequency is different between the first space S1 and the second space S2. Accordingly, occurrence of spatial resonance and amplification of noise due to the spatial resonance can be reduced.

In the electromechanically integrated unit 10 of the present embodiment, the bottom surface 46b of the flow path cover 46 has the uneven shape 46c. As described above, when the bottom surface 46b of the flow path cover 46 has the uneven shape 46c, the rigidity of the flow path cover 46 is increased. Vibration of the flow path cover 46 is therefore reduced. Moreover, due to the uneven shape 46c of the bottom surface 46b of the flow path cover 46, the height dimension of the first space S1 changes variously, and the resonance frequency in the first space S1 therefore also changes variously. Occurrence of spatial resonance and amplification of noise due to the spatial resonance can therefore be effectively reduced. The bottom surface 46b of the flow path cover 46 may not have the uneven shape 46c.

In the electromechanically integrated unit 10 of the present embodiment, the flow path cover 46 is attached to the converter case 42 at the fixing portions 48. The fixing portions 48 are located outside the first space S1. According to such a configuration, the flow path cover 46 can be supported by the wall 34b at a position inward of the fixing portions 48. Deformation and vibration of the flow path cover 46 can therefore be reduced. At least a part of the fixing portions 48 may be located inside the first space S1.

In the electromechanically integrated unit 10 of the present embodiment, multiple soundproof walls 54 may be provided. This can further reduce noise that is generated by the electromechanically integrated unit 10.

The first space S1 and the second space S2 are not limited to the above configuration, and the dimension of the first space S1 and the dimension of the second space S2 may be substantially equal in the height direction. In this case, the flow path cover 46 for the converter case 42 may extend over the first space S1 and the second space S2, or the flow path cover 46 may not be provided in the electromechanically integrated unit 10. Alternatively, the flow path cover may be provided on the top surface 32a of the inverter case 32.

Although a specific example of the technique disclosed in the specification is described in detail above, this specific example is illustrative only and is not intended to limit the scope of the claims. The technique described in the claims includes various modifications and alternations of the specific example illustrated above. The technical elements described in the present specification or the drawings exhibit technical utility alone or in various combinations, and are not limited to the combinations described in the claims as originally filed. The technique illustrated in the specification or the drawings can achieve a plurality of objects at the same time, and has technical utility by achieving one of the objects.

What is claimed is:

1. An electromechanically integrated unit, comprising:
a motor module containing a motor;
a first power converter circuit connected to the motor;
a first case housing the first power converter circuit, mounted on the motor module, and including a first surface;
a second power converter circuit connected to the first power converter circuit;
a second case that houses the second power converter circuit, that is mounted on the first case, and that includes a second surface facing the first surface of the first case; and
a wall configured to surround at least a part of a space between the first surface of the first case and the second surface of the second case.

2. The electromechanically integrated unit according to claim 1, wherein the wall is provided on either or both of the first surface of the first case and the second surface of the second case.

3. The electromechanically integrated unit according to claim 1, wherein the wall includes a first part and a second part, the first part being provided on the first surface of the first case, the second part being provided on the second surface of the second case and facing the first part.

4. The electromechanically integrated unit according to claim 1, wherein the wall includes a peripheral wall configured to form an enclosure between the first surface of the first case and the second surface of the second case, and a partition wall configured to divide a space surrounded by the peripheral wall into a first space and a second space.

5. The electromechanically integrated unit according to claim 4, wherein in a direction in which the first surface of the first case and the second surface of the second case face each other, a dimension of the first space and a dimension of the second space are different from each other.

6. The electromechanically integrated unit according to claim 4, wherein in a direction in which the first surface of the first case and the second surface of the second case face each other, a dimension of the first space is smaller than a dimension of the second space.

7. The electromechanically integrated unit according to claim 6, wherein:
a cover is provided on either the first case or the second case, the cover being interposed between the first surface of the first case and the second surface of the second case; and
the dimension of the first space is defined by the cover and the other of the first case and the second case.

8. The electromechanically integrated unit according to claim 7, wherein a surface of the cover that faces the first space has an uneven shape.

9. The electromechanically integrated unit according to claim 7, wherein:
the cover is provided on the second case; and
a coolant passage configured to cool the second power converter circuit is defined between the cover and the second surface of the second case.

10. The electromechanically integrated unit according to claim 7, wherein:
the cover includes a plurality of fixing portions at a peripheral edge of the cover, the fixing portions being fixed to the second case; and
the fixing portions are located outside the first space.

11. The electromechanically integrated unit according to claim 1, wherein the first power converter circuit is an inverter circuit, and the second power converter circuit is a converter circuit.
